(19) United States
(12) Patent Application Publication
(10) Pub. No.: US 2006/0269439 A1
(43) Pub. Date: Nov. 30, 2006

(54) Biological fluid treatment and disposal apparatus and method

(76) Inventor: James M. White, Longview, TX (US)

Correspondence Address: Ronald B. Sefrna, P.O. Box 567, Tyler, TX, 75710, US

(21) Appl. No.: 11/433,827

(22) Filed: May 15, 2006

Related U.S. Application Data
(63) Continuation-in-part of application No. 09/596,370, filed on Jun. 19, 2000.
(60) Provisional application No. 60/762,843, filed on Jan. 30, 2006.

(51) Int. Cl. C02F 1/50

(52) U.S. Cl. 422/1; 422/243

(57) ABSTRACT

An apparatus for treating and disposing of liquid waste, including but not limited to biological fluids, from a waste container includes a motive and carrier liquid flow passageway including a first venturi, a liquid waste flow passageway including a mixing chamber, connected to the first venturi so as to impose a suction and draw waste from a waste container through the liquid waste flow passageway when motive and carrier liquid is flowing through the first venturi; and a disinfectant line connected between a source of liquid disinfectant and the mixing chamber, so as to impose a suction and automatically draw liquid disinfectant through the disinfectant line to mix with the liquid waste when liquid waste is flowing through the mixing chamber. An alternative embodiment includes a backwash passageway with a backwash venturi to which the disinfectant line is connected, for selectively washing a waste container with a disinfectant solution.

### RELATED APPLICATION DATA

This application is a Continuation-In-Part of U.S. patent application Ser. No. 09/526,370, filed Jun. 19, 2000, and titled “Biological Fluid Disposal System”; and this application also claims the benefit of U.S. Provisional Patent Application Ser. No 60/762,843.

### FIELD OF THE INVENTION

The present invention generally relates to systems and apparatus for the disposal of contaminated fluids, and in its preferred embodiments more particularly relates to apparatus for conveying biological fluids from collection or storage containers to disposal, with disinfectant treatment of the fluids while the fluids are conveyed to disposal.

### BACKGROUND AND PRIOR ART

For a number of years, hospitals and other healthcare facilities have sought a safe and efficient means for handling and disposing of potentially hazardous biological fluids collected from patients during surgery and other procedures. It is very important to limit, if not fully eliminate, the exposure of hospital personnel to fluids that may contain pathogens and other hazardous substances.

Various means as used for collecting and handling fluid biological wastes, which may include blood, urine, mucus, and other bodily discharges. Known collection devices and systems include various types of containers into which the collected waste materials are accumulated, e.g., during surgery, and from which the wastes are dispensed or poured for disposal. Such containers are typically removed from the place where the waste materials are collected, and prior to any disinfection or decontamination of the fluid wastes. If the fluids are to be treated for disinfection or decontamination prior to disposal, treatment is usually performed at a location other than the place of collection, and before disposal in a receptacle or into a sewer.

Various patents relating to such biological fluid disposal systems have been issued. For example, U.S. Pat. No. 4,863,446, to Parker, teaches a combination fluid collection and disposal apparatus. This apparatus includes a collection unit for collecting the fluid and a treatment unit for coupling with the collection unit to remove the fluid from the collection unit and to dispose of the fluid. U.S. Pat. No. 4,957,491, to the same inventor, describes a similar apparatus.

U.S. Pat. No. 5,087,420, to Jackson, describes a batch-type disposal system for infectious waste in which a selected quantity of waste is drawn into a treatment container from one or more collection containers. A macerator is used to fragment solid wastes, which may be introduced to the apparatus separate from liquid wastes. The waste materials are mixed with a pre-selected measured quantity of a disinfectant, and the mixed waste materials and disinfectant material is circulated through the apparatus by a pump. After treatment and testing, the treated waste is pumped from the container for disposal.

U.S. Pat. No. 5,242,434, to Terry, discloses another medical waste handling system in which the infectious fluid is mixed with a disinfectant from another container before being discharged. Various conduits are connected to a collection chamber, and various types of pumps are employed to move fluid to and from the collection chamber.

U.S. Pat. No. 5,387,204, to Olsson et al., describes an apparatus and method for dosing an additive at the collection of liquid. The apparatus uses a suction to draw contaminated fluid through a tube. While the contaminated fluid is passed through the tube, it is mixed with a disinfectant before being forwarded for discharge.

U.S. Pat. No. 5,741,238, to Bradbury et al., discloses a medical and biological fluid collection and disposal system in which a vessel is divided into compartments which receive the biological fluid wastes through an inlet fitting. As the fluid is received, air in the vessel is displaced and is discharged through a vent line. When a level sensor senses that a level of fluid in the vessel is approaching a pre-selected maximum, a control circuit closes a valve in the vent line so as to block the discharge of air from the vessel and to create a back pressure that stops the receipt of further fluid.

U.S. Pat. No. 5,776,118, to Seifert et al., describes another collection and disposal system in which a collection vessel is connected for receiving waste fluids. The collection vessel is connected by a valve with a drain for draining the collected fluids. A fluid inlet is connected with an exterior water source to supply water through interconnected tubing to rinse waste residue from the collection vessel. A powdered reagent is received in a cup that is carried by a drawer to a position above the fluid mixing reservoir. A pump re-circulates water through the reservoir to make a disinfectant fluid concentrate which is supplied to a venturi to be selectively entrained in the rinse water. U.S. Pat. No. 5,885,240, to the same inventor, describes a similar system.

U.S. Pat. No. 5,914,047, to Griffiths, describes a batch-type bioharzardous waste collection and treatment system. The infectious fluid drawn into a treatment container by a pump, and is mixed with a metered amount of a treatment chemical that is also pumped into the container with the fluids to be treated. A peristaltic pump is used to circulate and mix the fluids, which are finally discharged from the apparatus using a electrically operated discharge pump. U.S. Pat. No. 6,039,724, to the same inventor, describes a similar system.

Although the apparatus and systems known in the prior art may be effective in treating biological waste materials, they suffer from certain disadvantages and drawbacks. The apparatus involved is complex and costly in construction, and may be equally complex to operate. These systems typically utilize a series of valves, either manually or electronically controlled and operated, and also typically utilize vacuum pumps, mixing pumps, and discharge pumps. The prior art apparatus and systems typically require an operator to open and close valves, activate and deactivate pumps, or at least set parameters for an automatic control system. Such apparatus, because of its relative mechanical and electrical/electronic complexity, also requires regular maintenance and repair, which may make the apparatus unavailable for use when needed.

In many instances effective treatment of biological fluids prior to disposal does not require the level of treatment or the level of control over treatment provided by the apparatus and systems of the prior art. There remains a need for an effective treatment and disposal apparatus that is relatively simple and economical in construction, that requires no moving parts such as valves and pumps for operation of the apparatus itself, that is easy to set up and use, and that provides continuous treatment and disposal from one or from a series of fluid containers through a simple container exchange. There is also a need for such an apparatus with an easy to use backwash system for cleaning and disinfecting the apparatus itself between uses.

### SUMMARY OF THE INVENTION

It is among the objects of the present invention to provide a treatment and disposal system that effectively and efficiently enables the proper disinfection and disposal of biological fluids and other fluid wastes.

It is further among the objects of the present invention to reduce the costs of fluid treatment and disposal apparatus and the costs of operation of such apparatus.

It is also among the objects of the invention to provide an apparatus for the treatment and disposal of fluid wastes without requiring the use of pumps to move fluids into, through, and from the apparatus.

It is still further among the objects of the invention to provide an apparatus for the treatment and disposal of fluids that does not require the operation of valves or controls during the processing of such fluids.

It is yet another of the objects of the invention to provide an apparatus for the treatment of fluids in a continuous, rather than a batch, process to enable the treatment and disposal of any quantity of fluid without requiring intermittent operation of the apparatus.

It is yet further among the objects of the invention to provide such a treatment and disposal apparatus with a backwash mode for cleaning out and disinfecting the apparatus and fluid containers.

In the preferred embodiment of the apparatus of the invention a water supply line is connected to a disposal line through a first venturi body. A waste line is connected to the venturi body, such that the flow of water through the venturi body as the motive fluid, creates, in accordance with the Bernoulli principle, a partial vacuum within the first venturi body at the point of connection of the waste line. As a result of the partial vacuum acting on the waste line, fluid waste is drawn into the waste line from a container, and from the waste line into the flow of water from the first venturi body through the waste line for disposal into a sewer or other appropriate disposal.

In the preferred embodiment a mixing chamber is disposed in the waste line, and a disinfectant line is connected between a source of disinfectant liquid and the mixing chamber in a “T” configuration. The flow of waste fluid through the mixing chamber induced by the first venturi body creates a sufficient suction acting on the disinfectant line to draw disinfectant liquid into the mixing chamber through the disinfectant line. The flows of waste fluid and disinfectant liquid are mixed as they flow through the waste line to the venturi body between the water supply line and the disposal line. Similarly, the turbulent flow though the first venturi body thoroughly mixes the waste/disinfectant mixture with the water flowing through the first venturi body, which carries the treated waste fluid to disposal.

The structure, features, and manner of achieving the stated and other objects of the invention will be described in detail below, with reference to the accompanying drawing figures.

### BRIEF DESCRIPTION OF THE DRAWINGS

FIG. 1 is a schematic illustration of the interconnected primary components of a preferred embodiment of the apparatus of the invention, with a fluid collection container in place for treatment and disposal through the apparatus of the invention.

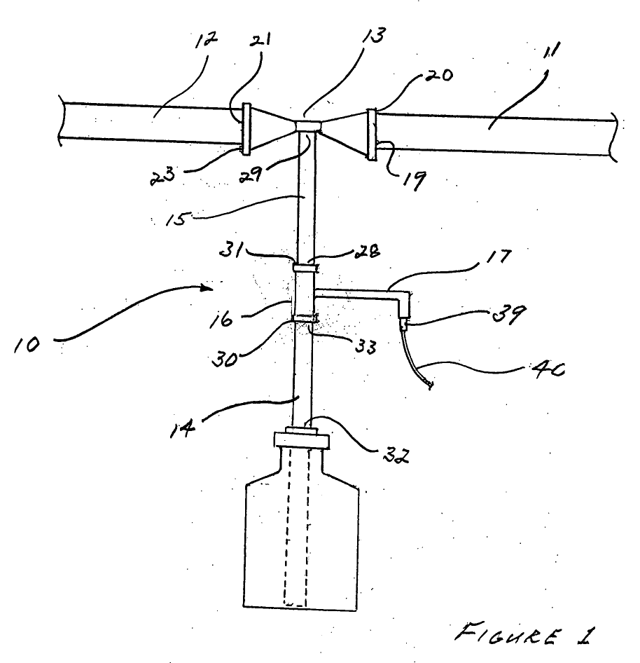

FIG. 2 is a schematic illustration of a preferred embodiment of the apparatus of the invention, within a housing, also illustrating connectors and valves that may be used to isolate the apparatus when not in use.

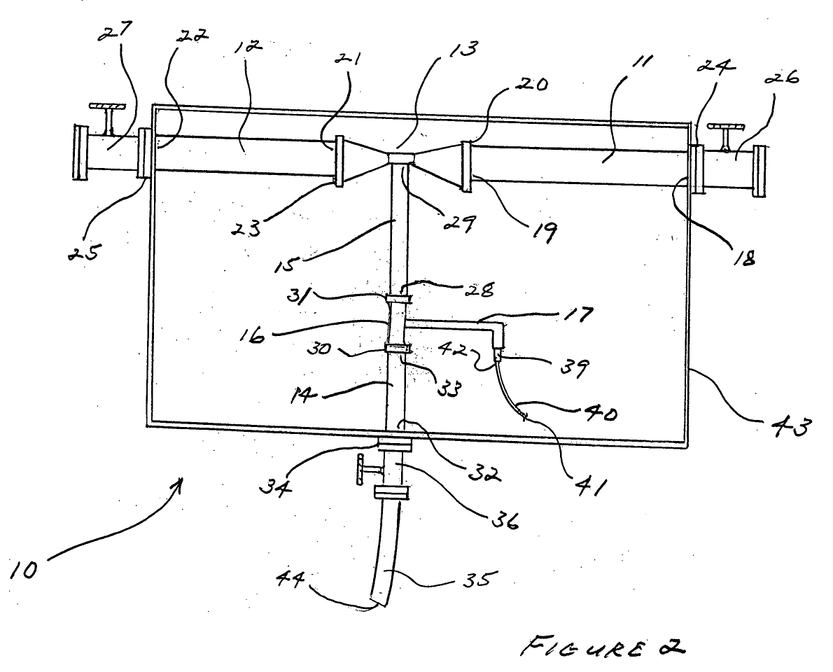

FIG. 3 is a schematic illustration of an alternative embodiment of the apparatus of the invention, utilizing a second venturi in place of a mixing chamber in the liquid waste flow path.

FIG. 4 is a schematic illustration of the primary components of an alternative embodiment of the apparatus of the invention, with a backwash system.

FIG. 5 is a schematic illustration of the alternative embodiment of the invention shown in FIG. 3, within a housing, and with connectors and valves for isolating the apparatus when not in use.

### DETAILED DESCRIPTION OF THE INVENTION

The preferred embodiment of the apparatus of the invention, generally designed by reference number 10, includes as its principal components a motive and carrier fluid inlet line 11, a disposal line 12, a primary venturi 13, connected in coaxial alignment between the motive fluid inlet line and the disposal line, a waste fluid inlet line 14, a treated waste line 15, mixing chamber 16 coaxially connected between the waste inlet line and the treated waste line, and a disinfectant line 17. Although the composition of the motive and carrier fluid used in the operation of the apparatus of the invention, flowing through line 11, is not limited to any particular fluid, it is contemplated that in the majority of instances water will be used as the motive and carrier fluid, and line 11 may also be referred to as a water inlet line. Similarly, references to water as the motive and carrier fluid are not intended as limitations, and it is to be understood that other fluids could be used within the scope of the invention.

In the preferred embodiment of the invention, lines 11, 12, 14, 15, and 17 comprise hollow substantially rigid pipes, formed of metal or a plastic material, such as PVC, suitable for the transport of water, the fluid waste materials to be treated and disposed of, and the disinfectant material used for treatment. However, it is to be understood that the material of construction of those lines is not critical to the scope of the invention, and other materials, such as flexible plastic tubing, may be used if desired. It is also preferred, but not required, that the same materials of construction be used for all lines carrying fluids within the apparatus.

Water inlet line 11 has a first end 18 and a second end 19, and is connected at second end 19 to first end 20 of venturi 13. Disposal line 12 has a first end 21 and a second end 22, and is connected at first end 21 to second end 23 of venturi 13, so as to form a passageway for the flow of water through the interior of line 11, the interior of venturi 13, and the interior of disposal line 12. In the preferred embodiment a coupling 24 is connected to first end 18 of water inlet line 11, for connection of the water inlet line to a source of water when the apparatus of the invention is prepared for use. Similarly, a coupling 25 is connected to second end 22 of disposal line 12, for connection of the outlet of disposal line 12 to a conduit used to convey the motive and carrier fluid with intermixed fluid wastes to a disposal point such as a sewer line. The apparatus of the invention is adaptable to permanent installation in, e.g., a hospital operating room, or to use as a portable apparatus that may be moved to different locations for use. In the event of a permanent installation, coupling 24 and coupling 25 may be simple plumbing fittings that form permanent connections. If desired or required to regulation, a conventional back-flow prevention device may be connected between the water supply line and the first end of water inlet line 11, but such a device is not a necessary component of the apparatus of the invention and does not affect the operation of the apparatus. Especially if the apparatus of the invention is constructed as a portable unit, but also with a permanently installed unit, valves 26 and 27 may be connected at the first end of line 11 and the second end of line 12, respectively, either integral with couplings 24 and 25 or as distinct components inward of the couplings. The purpose of valves 26 and 27 is to isolate the apparatus from external water supply and disposal when, for example, a portable apparatus is to be moved or when the apparatus is not in use. Valves 26 and 27, if used, merely open and close the passageway through water inlet line 11, venturi 13, and disposal line 12, and have no role in the function or operation of the apparatus during use.

Treated waste line 15, which has a first end 28 and a second end 29, is connected at second end 29 to primary venturi 13 within the low pressure zone, or throat, of venturi 13, and opens into the interior of venturi 13, forming a passageway for the flow of fluid from the interior of treated waste line 15 to the interior of venturi 13 and into disposal line 12. Mixing chamber 16, which has a first end 30 and a second end 31, is connected at second end 31 to the first end 28 of line 15. Waste inlet line 14, which has a first end 32 and a second end 33, is connected at second end 33 to the first end 30 of mixing chamber 16. A passageway is formed for the flow of fluids through waste inlet line 14, mixing chamber 16, and treated waste line 15, connected at venturi 13 to the passageway through water inlet line 11, venturi 13, and disposal line 12. In the preferred embodiment a coupling 34 is connected to first end 32 of waste inlet line 14, for connection of a flexible waste tube 35. A valve 36 may be disposed in waste inlet line 14 at its first end, or between its first and second ends, if desired. Valve 36, if used, like valves 26 and 27, merely opens and closes the passageway into waste inlet line 14 to isolate the apparatus when it is not in use, and has no role in the function or operation of the apparatus during use.

Disinfectant line 17, which has a first end 37 and a second end 38, is connected at second end 38 to mixing chamber 16 between the first and second ends thereof, and generally at a right angle relative to the longitudinal axis, or flow path for waste fluid through the chamber, and opens into the interior thereof. In the preferred embodiment of the apparatus, a flow restrictor 39 is connected to the first end of disinfectant line 17, and a flexible disinfectant tube 40 is connected at its second end 41 to flow restrictor 39. The first end 42 of disinfectant tube 40 is open, and is to be inserted into the interior of a vented (i.e., having an opening to the atmosphere) container of liquid disinfectant, below the surface of the disinfectant, during use of the apparatus. Flow restrictor 39 comprises a hollow, open ended body with a cross-sectional dimension that is smaller than the cross-sectional dimension of disinfectant line 17, and serves to restrict or limit the volume of disinfectant liquid allowed to flow through the flow restrictor and into the interior of disinfectant line 17. Flow restrictor 39 is not a valve, metering device, or injection device, and is not adjustable. It operates passively to restrict or limit disinfectant flow through the flow restrictor, and the rate of flow through the flow restrictor is solely a function of the pressure differential across it during operation of the apparatus.

Because the volumetric flow rate of disinfectant required for mixing with liquid waste to achieve the desired treatment is relatively low, the suction induced by the flow of the liquid waste longitudinally through mixing chamber 16 over the opening of disinfectant line 17 into the mixing chamber is sufficient to draw an appropriate flow of disinfectant liquid into the mixing liquid waste flow.

In the preferred embodiment the apparatus of the invention includes a housing 43 to surround and enclose the components of the apparatus described above. Housing 43 is penetrated by apertures through which the first end 18 of water line 11, the second end 22 of disposal line 12, and the first end 31 of waste inlet line 14, respectively, extend. Couplings 24, 25, and 34, and valves 26, 27, and 37, if used, are disposed exterior to the housing so that they are readily accessible without opening the housing. The configuration of housing 43 is a matter of choice and efficient utilization of space, and is not significant to the invention. If a unit of the apparatus is to be portable, wheels (not shown) may be connected to the housing to facilitate transportation. A container of disinfectant liquid may be disposed in the interior of housing 43 or may be positioned exterior to the housing. If disposed in the interior, it is preferred that an opening be provided in the housing for access to the disinfectant container. If the disinfectant container is disposed exterior to the housing, an additional aperture in the housing is provided for disinfectant tube 38.

The embodiment of the apparatus described above is used by connecting a source of motive and carrier fluid, typically water, to water inlet line 11, and connecting the second end or outlet of disposal line 12 to, preferably, a sewer. A container for receiving the mixture of motive fluid (water) and treated waste from the apparatus may be used instead of a direct connection to a sewer, but the volume of that mixture can be relatively high, and the volume of a receiving container, if used, should be correspondingly large.

Valves 26 and 27, if used, are opened, and a flow of motive and carrier fluid, e.g., water, through line 11, venturi 13, and line 12 is initiated. The flow of an incompressible fluid such as water through the interior of venturi 13, which is of smaller cross-sectional area than lines 11 and 12, results in an increase in the velocity of the flow through the interior of the venturi and a decrease in pressure, in accordance with Bernoulli's Principle. Since the interior of treated waste line 15 is in communication with the interior of venturi 13, the reduction of pressure in venturi 13 results in a reduction of pressure in the interior of treated waste line 15. The interior of treated waste line is in communication with the interior of second venturi 16 and waste inlet line 14, and the internal pressure through that passageway is also reduced, resulting in a suction at the open end of the passageway; i.e., at the open end 44 of flexible waste tube 35. Fluid is drawn into the waste tube, through waste inlet line 14, mixing chamber 16, and treated waste line 15 to venturi 13, and from venturi 13 through disposal line 12.

The fluid drawn into and through the described passageway will be whatever fluid surrounds the open end of the passageway; e.g., the open end of flexible waste tube 35. If the flexible waste tube is not immersed in a container of liquid, but is in the open atmosphere, the fluid drawn through the passageway is air. Air is a compressible fluid and is of much lower density than water. The flow of air through the interior of mixing chamber 16 does not provide a sufficient motive force or create a sufficient suction to draw disinfectant liquid from a container, through flow restrictor 39, and through the interior of disinfectant line 17 to the mixing chamber. Accordingly, even though a motive liquid (e.g., water) is flowing through line 11, venturi 13, and disposal line 12 and is drawing air through waste inlet line 14, mixing chamber 16, and treated waste line 15, no disinfectant liquid is drawn through the apparatus.

When a container of liquid waste, the container having an opening or vent to the atmosphere, is provided, and the flexible waste tube is immersed in the liquid waste, the liquid waste is then caused to flow into and through through the waste tube, waste inlet line, mixing chamber, and treated waste line as a result of the differential between atmospheric pressure and the reduced pressure within that passageway. The flow of liquid waste, which is an incompressible fluid of much higher density than air, through mixing chamber 16 creates a sufficient pressure drop and suction to draw disinfectant liquid from the vented disinfectant container and into the interior of the mixing chamber, where the disinfectant liquid is mixed with the liquid waste, initiating disinfection treatment. The mixture of liquid waste and disinfectant liquid is drawn through treated waste line 15, where the waste and disinfectant remain in intimate contact, into venturi 13 and into the flow of motive and carrier liquid. As the mixture of liquid waste and disinfectant is drawn into and through venturi 13 it is mixed with the motive and carrier fluid and carried through disposal line 12 to, e.g., a sewer.

When a container of liquid waste has been emptied, air is again drawn into and through the apparatus rather than liquid waste. As soon as the flow of liquid waste ceases, the flow of disinfectant liquid ceases, and will not resume until liquid is again drawn through the apparatus to create a sufficient suction for disinfectant flow. It can be seen then that the introduction of disinfectant liquid to the apparatus for treatment of liquid wastes is automatic and self-regulating, without the need for valves, pumps, pressure injectors or other means of controlling disinfectant introduction. The flow rate of disinfectant liquid is controlled automatically, without outside intervention or operator adjustment, by the flow rate of liquid waste through the apparatus, which is itself a function of the flow rate of the motive and carrier fluid. As long as the flow of motive and carrier liquid is maintained, the apparatus of the invention is in a state of readiness to treat and dispose of liquid wastes. Treatment of waste begins immediately and automatically when waste liquid is introduced, and ceases immediately and automatically when the liquid waste is exhausted or removed.

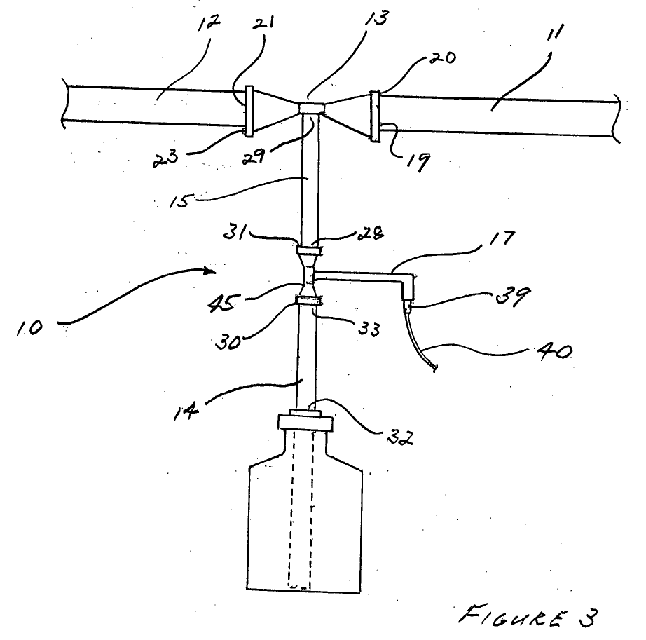

In an alternative embodiment, or variation of the apparatus described above, a second venturi 45 may be used in place of mixing chamber 16, as illustrated in FIG. 3. With a venturi 45 in the liquid waste flow path a more significant pressure drop is created within the throat of the venturi, and thesuction acting to draw disinfectant liquid into the liquid waste flow from disinfectant line 17 is increased. As a result of the increased suction, the flow rate of disinfectant liquid in comparison to the flow rate of liquid waste can be increased, if desired. The structure of venturi 45, i.e., the constriction of the throat of the venturi, can be selected to induce a desired pressure drop in the throat of the venturi and thus select the suction imposed on disinfectant line 17. Despite the higher pressure drop created within venturi 45 in response to the flow of liquid waste through the venturi, when air alone is drawn through venturi 45 there is insufficient suction within the throat of the venturi to draw disinfectant liquid from the disinfectant line into the venturi. Therefore, as described above with regard to the preferred embodiment, the apparatus of the invention is self-regulating with regard to the flow of disinfectant liquid, providing a flow of disinfectant liquid only when liquid waste is flowing through venturi 45 and not otherwise.

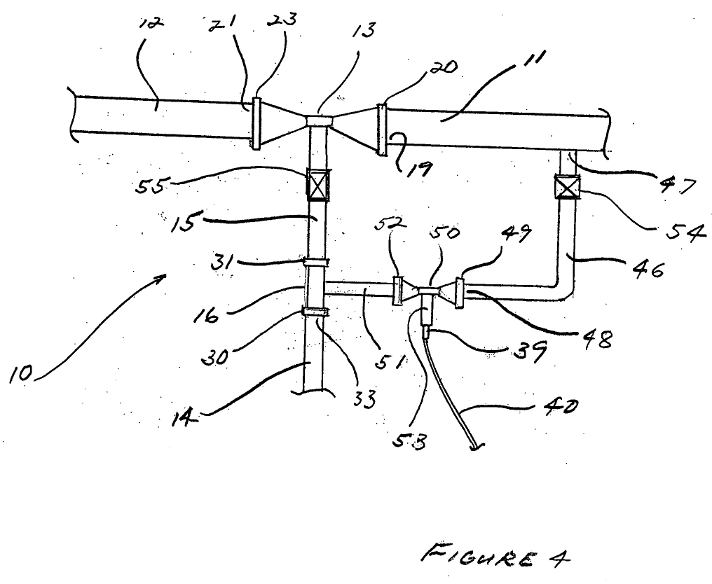

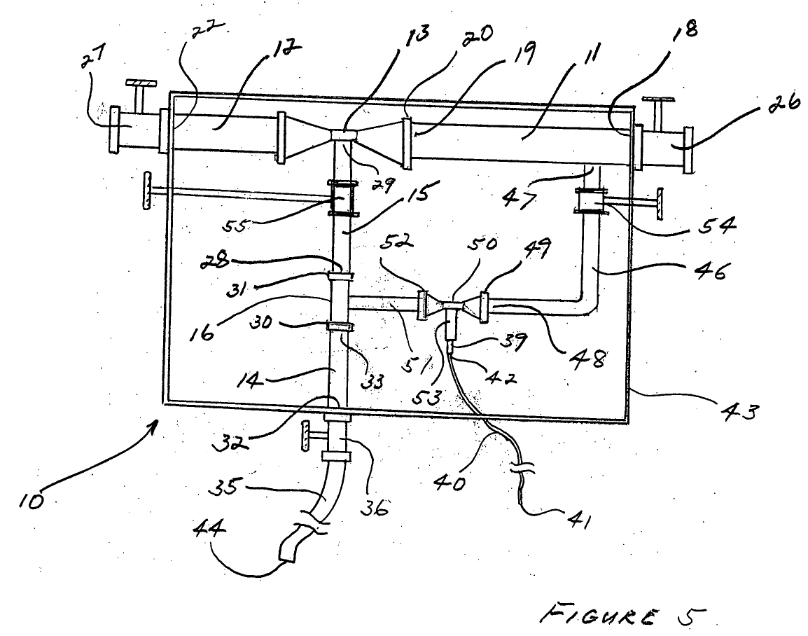

In addition to treating and disposing of waste from collection containers, it is also desirable to provide the capability of washing and disinfecting the containers themselves. An alternative embodiment of the apparatus of the invention, illustrated in FIGS. 4 and 5, includes a backwash loop to provide that capability. In this embodiment of the invention a wash water line 46 is connected at its first end 47 to water inlet line 11 upstream of primary venturi 13. The second end 48 of wash water line 46 is connected to first end 49 of a backwash venturi 50. A first disinfectant line 51 is connected between second end 52 of backwash venturi 50 and mixing chamber 16 or second venturi 45, as desired, in place of disinfectant line 17 of the previously described embodiments. In this embodiment a second disinfectant line 53 is connected to backwash venturi 50 within the low pressure zone of the backwash venturi. As in the primary embodiment described above, flow restrictor 39 is used to limit the flow of disinfectant into second disinfectant line 53 from a disinfectant source in both treatment/disposal mode and backwash mode of operation of the apparatus. A valve 54 is disposed in wash water line 46 between its first and second ends; i.e., between water inlet line 11 and backwash venturi 50. A valve 55 is disposed in treated waste line 15 between its first and second ends; e.g., between mixing chamber 16 and primary venturi 13. Valves 54 and 55 function to switch the operation of the apparatus between treatment/disposal mode and backwash mode.

To operate the alternative embodiment of the apparatus in treatment/disposal mode, valve 54 is closed, to prevent the flow of water through wash water line 46 to backwash venturi 50, and valve 55 is opened, to permit full flow of treated waste through treated waste line 15. In this operating mode, liquid waste is drawn from a waste collection container through waste inlet line 14, mixing chamber 16, treated waste line 15 and into primary venturi 13 by the flow of water through that venturi, and from the apparatus through disposal line 12 to a sewer or other disposal point. The flow of liquid waste through mixing chamber 16 draws disinfectant from the disinfectant source into backwash venturi 50 through second disinfectant line 53 and then through first disinfectant line 51 to mixing chamber 16, where the disinfectant is mixed with the liquid waste flowing through mixing chamber 16. With valve 52 closed no water is allowed to flow through backwash venturi 50, and that venturi functions only as a connector between the first and second disinfectant lines when the apparatus is operated in treatment/disposal mode.

To operate in backwash mode, valve 54 is opened and valve 55 is closed. A portion of the water flowing through water inlet line 11 is diverted through wash water line 46, through backwash venturi 50, and to mixing chamber 16. The flow path through treated waste line 15 is closed by valve 55, and the wash water flows downward from venturi 16 through waste inlet line 14 to a collection container to be cleaned. As the wash water flows through backwash venturi 50 a low pressure zone within the venturi is created, drawing disinfectant into venturi 50 through second disinfectant line 53 to mix with the wash water to form a disinfectant solution, which flows from venturi 50 to mixing chamber 16 through first disinfectant line 51 and then through waste inlet line 14 into the collection container. When the collection container is full or has received the desired volume of disinfectant solution, valve 54 is closed and valve 55 is opened to return the apparatus to treatment/disposal mode. In the manner described above, in this mode the disinfecting solution and residual liquid waste is drawn into waste inlet line 14, through mixing chamber 16, treated waste line 15, and venturi 13 for disposal. It will be understood that operation of the apparatus in backwash mode not only provides for washing and disinfecting collection containers, but also results in the cleaning and disinfection of the internal passageways of the apparatus itself.

The foregoing description of the structure of the primary and alternative embodiments of the apparatus of the invention and of the methods of use of the apparatus for treating and disposing of liquid wastes is intended to be illustrative and not limiting. Further alternative embodiments and variations may be devised by those of skill in the art on the basis of the foregoing description and within the scope of the invention in accordance with the following claims.

1. Apparatus for disinfecting and disposing of liquid waste from a collection container, comprising
a motive and carrier fluid inlet line having a hollow interior, a first end, and a second end, said motive and carrier fluid inlet line to be connected at said first end to a source of motive and carrier fluid;
a first venturi having a first end and a second end, with a longitudinal passageway between said first end and said second end, connected at said first end to said second end of said motive and carrier fluid inlet line;
a disposal line having a hollow interior, a first end, and a second end, connected at said first end to said second end of said first venturi, for conveying disinfected liquid waste mixed with said motive and carrier fluid to a disposal means;
a treated waste line having a hollow interior, a first end, and a second end, connected at said second end to said first venturi with said interior of said treated waste line in fluid flow communication with said passageway through said first venturi, such that flow of said motive and carrier fluid through said first venturi from said motive and carrier fluid inlet line to said disposal line induces a suction in said treated waste line;
a suction inducing mixing chamber having a first end and a second end, with a longitudinal passageway between said first end and said second end of said mixing chamber, connected at said second end to said first end of said treated waste line;
a waste inlet line having a hollow interior, a first end, and a second end, connected at said second end to said first end of said mixing chamber, said first end to receive liquid waste therethrough into said interior of said waste inlet line, through said waste inlet line, through said mixing chamber, through said treated waste line, and into said first venturi in response to said suction created by said flow of said motive and carrier fluid through said first venturi, and from said first venturi through said disposal line along with said motive and carrier fluid to said disposal means; and
a disinfectant line having a hollow interior, a first end, and a second end, connected at said second end to said mixing chamber with said interior of said disinfectant line in fluid flow communication with said passageway through said mixing chamber, such that flow of said liquid waste through said mixing chamber from said waste inlet line to said treated waste line induces a suction in said disinfectant line, said first end of said disinfectant line to be connected to a source of liquid disinfectant, such that said suction induced in said disinfectant line by the flow of said liquid waste through said chamber draws disinfectant through said disinfectant line to said mixing chamber to mix with said liquid waste during flow of said liquid waste through said mixing chamber.

2. The apparatus of claim 1, further comprising a disinfectant flow restrictor connected between said first end of said disinfectant line and said source of liquid disinfectant, for limiting the flow rate of said liquid disinfectant from the source of liquid disinfectant into said disinfectant line.

3. The apparatus of claim 2, wherein said disinfectant flow restrictor comprises a body with a longitudinal passageway extending through said body, the cross-sectional area of said passageway being less than the cross-sectional area of said disinfectant line.

4. The apparatus of claim 1, further comprising
a first coupling connected to said first end of said motive and carrier fluid inlet line, for connecting said motive and carrier fluid inlet line to said source of motive and carrier fluid; and
a second coupling means connected to said second end of said disposal line, for connecting said disposal line to said disposal means.

5. The apparatus of claim 1, further comprising a motive and carrier fluid valve connected to said first end of said motive and carrier fluid line, for opening said motive and carrier fluid line to the flow of said motive and carrier fluid to initiate operation of the apparatus, and closing said motive and carrier fluid line to the flow of said motive and carrier fluid to terminate operation of the apparatus.

6. The apparatus of claim 1, further comprising a liquid waste valve connected to said first end of said waste inlet line, for opening and closing said waste inlet line to the flow of liquid waste therethrough.

7. The apparatus of claim 4, further comprising a housing having an interior, wherein said motive and carrier fluid inlet line, said first venturi, said disposal line, said treated waste line, said mixing chamber, said disinfectant line, and at least a portion of said waste inlet line are disposed in said interior of said housing, and wherein said first coupling means and said second coupling means are disposed externally of said housing.

8. The apparatus of claim 4, further comprising a third coupling means connected to said first end of said waste inlet line, for connecting said waste inlet line to a liquid waste collection container.

9. The apparatus of claim 8, further comprising a housing having an interior, wherein said motive and carrier fluid inlet line, said first venturi, said disposal line, said treated waste line, said mixing chamber, said liquid waste line, and said disinfectant line are disposed in said interior of said housing, and wherein said first coupling means, said second coupling means, and said third coupling means are disposed externally of said housing.

10. The apparatus of claim 5, further comprising a liquid waste valve connected to said first end of said waste inlet line, for opening and closing said waste inlet line to the flow of liquid waste therethrough.

11. The apparatus of claim 1, further comprising a housing having an interior, wherein said motive and carrier fluid inlet line, said first venturi, said disposal line, said treated waste line, said mixing chamber, said liquid waste line, and said disinfectant line are disposed in said interior of said housing, and wherein said motive and carrier fluid valve and said liquid waste valve are disposed externally of said housing.

12. The apparatus of claim 8, further comprising a flexible waste tube extending between said third coupling means and a liquid waste collection container.

13. The apparatus of claim 2, further comprising a disinfectant tube extending between said disinfectant flow restrictor and the source of liquid disinfectant.

14. The apparatus of claim 1, wherein said mixing chamber is a venturi.

15. Apparatus for disinfecting and disposing of liquid waste from a collection container when operated in a treatment/disposal mode, and for selectively washing the collection container with a disinfectant solution when operated in a backwash mode, comprising
a water inlet line having a hollow interior, a first end, and a second end, said water inlet line to be connected at said first end to a source of pressurized water;
a first venturi having a first end and a second end, with a longitudinal passageway between said first end and said second end, connected at said first end to said second end of said water inlet line;
a disposal line having a hollow interior, a first end, and a second end, connected at said first end to said second end of said first venturi, for conveying disinfected liquid waste mixed with water for disposal;
a treated waste line having a hollow interior, a first end, and a second end, connected at said second end to said first venturi with said interior of said treated waste line in fluid flow communication with said passageway through said first venturi, such that flow of water through said first venturi from said water inlet line to said disposal line induces a suction in said treated waste line;
a treated waste valve connected to said treated waste line for opening said treated waste line to the flow of liquid therethrough for operation in treatment/disposal mode, and for closing said treated waste line to the flow of liquid therethrough for operation in backwash mode;
a suction inducing mixing chamber having a first end and a second end, with a longitudinal passageway between said first end and said second end of said mixing chamber, connected at said second end to said first end of said treated waste line;
a waste inlet line having a hollow interior, a first end, and a second end, connected at said second end to said first end of said mixing chamber, said first end to receive liquid waste therethrough into said interior of said waste inlet line, through said waste inlet line, through said mixing chamber, through said treated waste line, and into said first venturi in response to said suction created by said flow of water fluid through said first venturi, and from said first venturi through said disposal line along with such water to disposal;
a wash water line having a hollow interior, a first end, and a second end, connected at said first end to said water inlet line so as to create a passageway for the flow of water from said water inlet line into said interior of said wash water line;
a wash water valve connected to said wash water line for opening said passageway for the flow of water from said water inlet line into said interior of said wash water line for operation in backwash mode, and closing said passageway for operation in treatment/disposal mode;
a backwash venturi having a first end and a second end, with a longitudinal passageway between said first end and said second end of said backwash venturi, connected at said first end to said second end of said wash water line;
a first disinfectant line having a hollow interior, a first end, and a second end, connected at said first end to said second end of said back wash venturi and connected at said second end to said mixing chamber with said interior of said first disinfectant line in fluid flow communication with said passageway through said mixing chamber, such that flow of liquid waste through said mixing chamber from said waste inlet line to said treated waste line during operation in treatment/disposal mode induces a suction in said first disinfectant line; and
a second disinfectant line having a hollow interior, a first end, and a second end, connected at said second end to said backwash venturi with said interior of said second disinfectant line in fluid flow communication with said passageway through said backwash venturi, such that flow of water through said backwash venturi from said wash water line to said first disinfectant line during operation in backwash mode induces a suction in said second disinfectant line, said first end of said second disinfectant line to be connected to a source of liquid disinfectant.

16. The apparatus of claim 15, further comprising a flow restrictor disposed in said second disinfectant line, for limiting the maximum volumetric flow rate of said liquid disinfectant through said second disinfectant line.

17. A method of treating liquid waste with a liquid disinfectant and conveying such treated liquid waste to disposal, comprising the steps of initiating and maintaining a flow of a motive and carrier liquid from a pressurized source through a motive and carrier liquid inlet line, longitudinally through a first venturi so as to create a low pressure zone within said first venturi, and through a disposal line to disposal;
establishing a flow passageway for liquid waste through a waste inlet line having a first end to be immersed in a container of liquid waste, longitudinally through a mixing chamber so as to create a low pressure zone within said mixing chamber when liquid waste is flowing therethrough, and through a treated waste line having a first end and a second end, connected at said first end to said mixing chamber and connected at said second end to said first venturi within said low pressure zone of said first venturi, thereby creating a reduced pressure in said flow passageway for liquid waste;
establishing a flow passageway for liquid disinfectant from a source of liquid disinfectant through a disinfectant line having a first end and a second end, with said first end immersed in the disinfectant liquid and connected at said second end to said mixing chamber within said low pressure zone of said mixing chamber, such that a reduced pressure is created in said disinfectant line only when liquid waste is flowing through said mixing chamber so as to create said low pressure zone within said mixing chamber; and
immersing said first end of said waste inlet line in liquid waste in said liquid waste container, whereupon said liquid waste is caused to flow from said container through said waste inlet line and through said mixing chamber, thereby creating said low pressure zone within said mixing chamber and creating said reduced pressure in said disinfectant line, causing liquid disinfectant to flow through said disinfectant line and into said mixing chamber to mix with said liquid waste, and said mix of said liquid waste and said disinfectant is caused to flow through said treated waste line into said first venturi to further mix with said motive and carrier liquid and be conveyed through said disposal line with said motive and carrier liquid to disposal.

18. The method of claim 17, wherein said flow passageway for liquid disinfectant includes a flow restrictor for the purpose of limiting the maximum volumetric flow rate of said liquid disinfectant through said disinfectant line.

19. The method of claim 18, comprising the additional steps, for backwashing the liquid waste container with disinfectant solution, of
establishing a flow passageway for a portion of said motive and carrier liquid from said motive and carrier liquid inlet line through a wash liquid line, longitudinally through a backwash venturi, and to said low pressure zone of said mixing chamber;
establishing said flow passageway for said liquid disinfectant to said mixing chamber through said backwash venturi;
closing said flow passageway through said treated waste line; and
opening said flow passageway through said wash liquid line, thereby causing a portion of said motive and carrier liquid to flow through said wash liquid line, through said backwash venturi, thereby creating a low pressure zone within said backwash venturi and causing liquid disinfectant to flow through said disinfectant line into said backwash venturi and mix with said motive and carrier liquid flowing therethrough to form a disinfectant solution, said disinfectant solution being caused to flow from said backwash venturi through said mixing chamber and through said waste inlet line into said liquid waste container.

20. The method of claim 19, comprising the additional steps of
opening said flow passageway through said treated waste line; and
closing said flow passageway through said wash liquid line, causing said disinfectant solution to flow from the liquid waste container through said waste inlet line, said mixing chamber, and said treated waste line into said first venturi, mix with said motive and carrier liquid, and be conveyed through said disposal line to disposal, thereby removing said disinfectant solution from said liquid waste container.
